(19) United States
(12) Patent Application Publication
(10) Pub. No.: US 2009/0070193 A1
(43) Pub. Date: Mar. 12, 2009

(54) SYSTEM AND METHOD FOR INTELLECTUAL PROPERTY MORTGAGING

(76) Inventor: Isreal Hicks, Arlington, WA (US)

Correspondence Address: BLACK LOWE & GRAHAM, PLLC, 701 FIFTH AVENUE, SUITE 4800, SEATTLE, WA, 98104, US

(21) Appl. No.: 12/203,089

(22) Filed: Sep. 2, 2008

Related U.S. Application Data
(60) Provisional application No. 60/969,500, filed on Aug. 31, 2007.

(51) Int. Cl. G06Q 10/00; G06Q 50/00

(52) U.S. Cl. 705/10

(57) ABSTRACT

A method that provides industry specific consulting, management, and production services to individual IP producers. More specifically, the method provides intellectual property leveraging strategies, accounting, and finance methods for individual IP producers based on a contractual relationship wherein a business entity delivers the industry specific consulting, management, and production services to the individual IP producer based on the evaluated value of the produced IP product.

### RELATED APPLICATIONS

This application claims priority to and incorporates by reference in its entirety U.S. Provisional Patent Application Ser. No. 60/969,500 filed Aug. 31, 2007.

### COPYRIGHT NOTICE

This disclosure is protected under United States and International Copyright Laws. ©2007 Isreal Hicks. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to a business method that provides industry specific consulting, management, and production services to individual IP producers, and more specifically providing intellectual property leveraging strategies for individual IP producers based on a contractual relationship.

### BACKGROUND OF THE INVENTION

The music industry itself is at best stagnant, and at worst, declining as more and more artists/IP producers see managing their own promotion and distribution as a more lucrative way to grow themselves and their art as products than allowing themselves to be “discovered” by a record label and face the risks of losing control of their creative processes. As independent artists/IP producers like Slim Thug and the band Shiny Toy Guns not only sustain themselves, but come to record labels as well-established businesses in their own right, they are able to negotiate better agreements for themselves, or better yet, continue to exist and thrive independent of record label support.

While some artists/IP producers have successfully leveraged their intellectual property to establish a positive revenue stream, this type of business development is often outside the reach of more inexperienced artists/IP producers who are new to the business side of music, lack funds and/or connections. What is needed are intellectual property protection and leveraging services available to small businesses and individuals who wish to manage the production, sale, and distribution/accessibility of their IP products thus leveling the playing field, and giving opportunity for success for all potential entrants regardless of funding or connections.

### SUMMARY OF THE INVENTION

An embodiment of the present invention is a business method for consulting, management, and production wherein a business entity provides intellectual property leveraging strategies, accounting, and finance methods for individual IP producers. The method includes performing an evaluation of an IP product based on the market strength of the IP product produced by the IP producer. The method also includes determining the IP producer's IP needs to produce the IP product. Those needs include at least one of the group of IP development, production, marketing, and/or distribution. The method further includes establishing and documenting a mortgage for the IP producer based on the producer's IP needs and the evaluated IP market strength of the IP product, wherein the business entity takes a financial interest in said IP product. The method additionally includes providing IP needs to the IP producer to produce the IP product, wherein those needs include at least one of the group of IP development, production, marketing, or distribution.

### BRIEF DESCRIPTION OF THE DRAWINGS

Preferred and alternative examples of the present invention are described in detail below with reference to the following drawings:

FIG. 1 is a pie chart to evaluate music sales based on genre of music in one embodiment of the invention;

FIG. 2-1 is an exemplary application the music mortgage provider can utilize in the evaluation process;

FIG. 2-2 is an exemplary tally sheet/evaluation form the music mortgage provider can utilize in its scoring process; and

FIG. 3 is a table of the competitive analysis of the music mortgage provider business entity in an exemplary embodiment of the present invention.

### DETAILED DESCRIPTION OF THE PREFERRED EMBODIMENT

An embodiment of the present invention relates to the artistic and/or intellectual property/product development business industry focusing in one embodiment on the music industry. It is to be understood that the music production, recording, and distribution industry is one exemplary embodiment, and that the invention applies to other areas of intellectual property development and distribution.

An embodiment of the present invention relates to a system and method for publishing and music/IP product mortgaging that offers production, distribution, promotion, and intellectual property protection services to small businesses and individual IP producers who wish to manage the sale and accessibility of their IP products. By providing music/IP mortgaging an artist's/IP producer's IP product is leveraged, thus driving innovation by enabling artists/IP producers to bring their creations to the world on their own terms. Moreover, by providing the means to produce and distribute the music/IP product, the music/IP mortgage provider enables new artists/IP producers and innovators to broaden the available audience for their IP products by being a one-stop shop for their service needs and encourages the development of high-quality IP products from talented innovators to raise the bar in their chosen industries, serving as activists for industry change, leveling the playing field and the opportunity for success for all potential entrants regardless of funding or connections.

An embodiment of the present invention supports artists/IP producers willing to take control of their creations and the distribution of those creations to customers/IP consumers. It further raises the bar of innovation by enabling and supporting artists/IP producers who otherwise wouldn't have the opportunity to reach their target audiences.

An embodiment of the present invention relates to the music industry and its talent but can also be used in other industries and their talent, such as software, popular invention, literary and business innovation.

An embodiment of the present invention recognizes that unlike successful independent artists/IP producers such as Slim Thug and Shiny Toy Guns, who had the access to the start-up capital needed to get studio time, print and press CDs (and/or other tangible media), negotiate with and distribute with record shops to carry their IP products, and to market themselves, there are many artists/IP producers with the desire, ability, and drive to be successful, but just need that jumpstart.

An embodiment of the present invention allows artists/IP producers to completely outsource the work that a traditional record company would do on their behalf to a music/IP mortgage provider, based on a contract that is constructed and designed by the artists/IP producers themselves. In one embodiment of the invention, an artist/IP producer can borrow the services needed to promote one song/IP product against the IP rights of that one song/IP product. In contrast a conventional record company agreement often obligates the artist/IP producer to a multi-album deal. An embodiment of the present invention adds the flexibility of time and separation of individual IP products, whether it's a song, a design for a toy, a manuscript, and/or a software prototype, so that the artist/IP producer has more control over what direction their business takes and how it will get there.

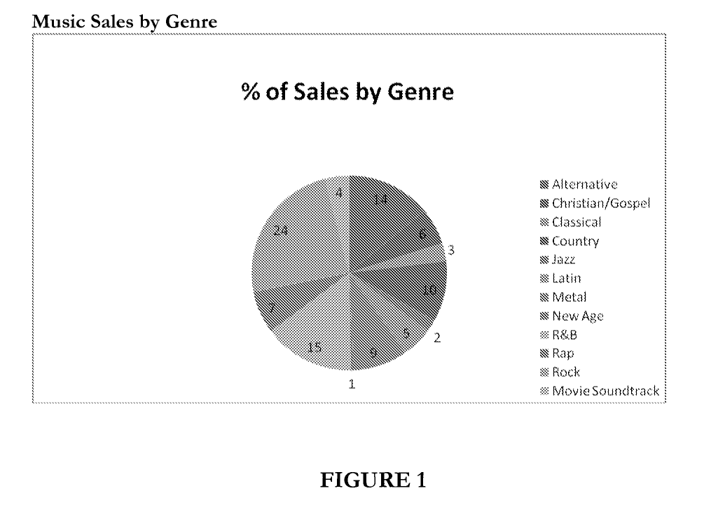

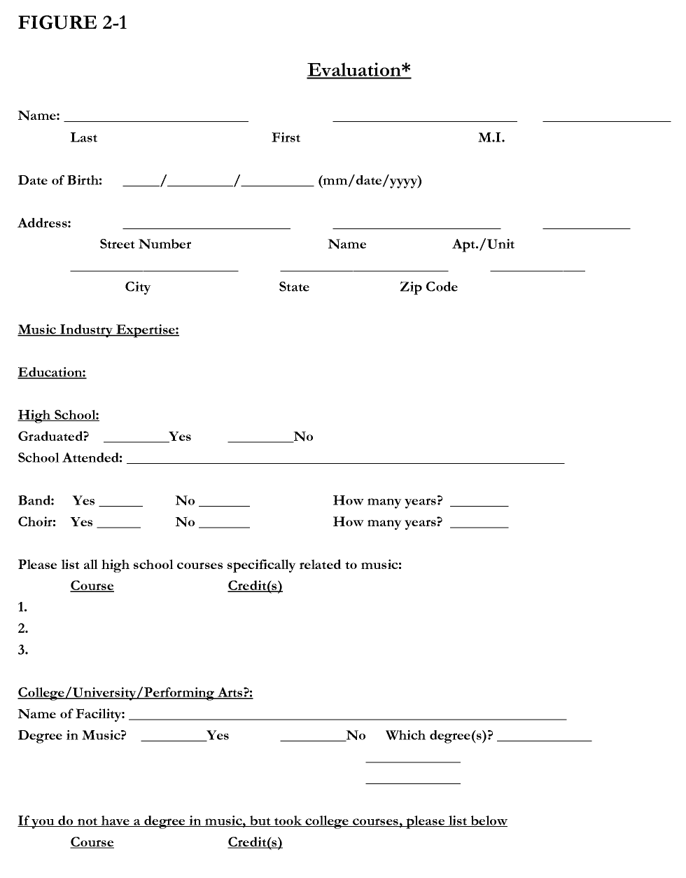

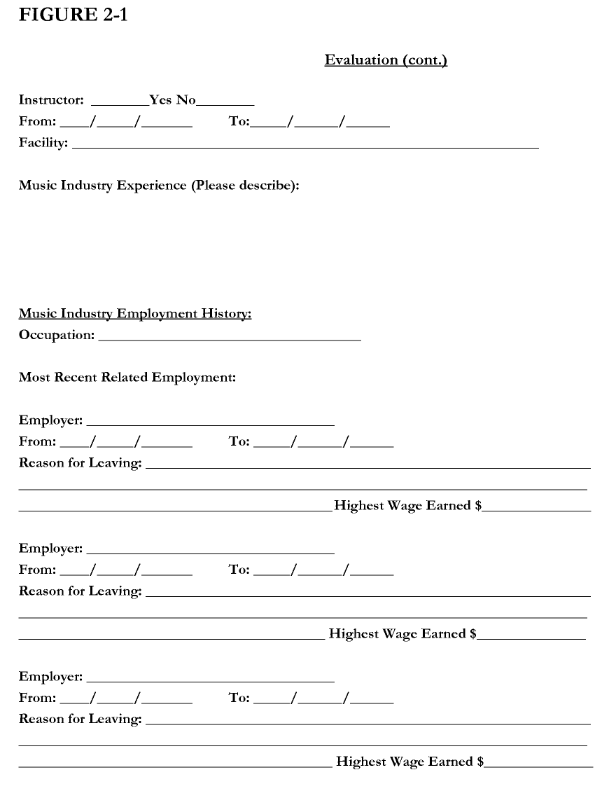

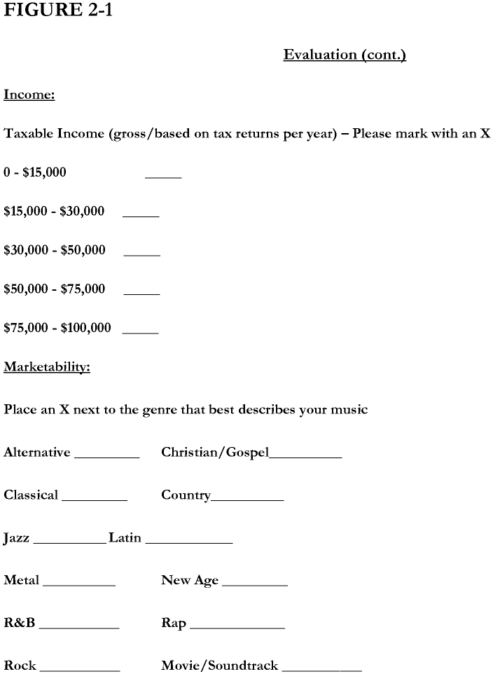

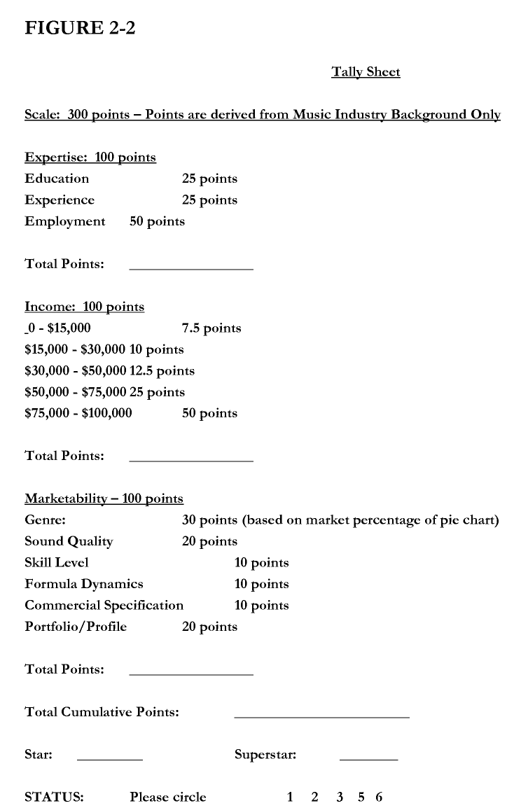

An embodiment of the present invention is a method by which a music mortgage provider evaluates each piece of intellectual property to be valued based on a credit score much like those utilized by banking institutions. Turning to FIG. 1 and FIG. 2-1, in an exemplary embodiment, each individual piece of music/intellectual property has a value that can be assessed based on genre and evaluation of the IP producer. The music mortgage provider places that piece of property in its inventory and/or certifies the purchase value for sale. The music mortgage provider becomes an advocate for both the music mortgage provider as a business entity and the music/IP producer.

Referring now to FIG. 2-2, in this exemplary embodiment, the music mortgage provider's standardized scoring can be based on, although is not limited to the following components:

| | | |
|---|---|---|
| Scale: | 300 | points - Points are derived from |
| | | Music Industry Background Only |
| Expertise: | 100 | points |
| Education: | 25 | points |
| Experience: | 25 | points |
| Employment: | 50 | points |
| Income: | 100 | points |
| 0-$15,000 | 7.5 | points |
| $15,000-$30,000 | 10 | points |
| $30,000-$50,000 | 12.5 | points |
| $50,000-$75,000 | 25 | points |
| $75,000-$100,000 | 50 | points |
| Marketability: | 100 | points |
| Genre: | 30 | points (based on market percentage of |
| | | pie chart) |
| Sound Quality: | 20 | points |
| Skill Level: | 10 | points |
| Formula Dynamics: | 10 | points |
| Commercial Specification: | 10 | points |
| Portfolio/Profile: | 20 | points |

In the exemplary embodiment, total points awarded to the IP product/producer are then converted into an overall “Status” which, in turn, gives each a dollar value.

| | | |
|---|---|---|
| 1) | Mediocre: | 0-100 points |
| | Value: | $0-$99.00 |
| 2) | Amateur: | 101-200 points |
| | Value: | $100.00-$299.00 |
| 3) | Professional: | 201-300 points |
| | Value: | $300.00-$499.00 |
| 4) | Master: | 301 and above |
| | Value: | $500.00 and above |

The music mortgage provider can offer IP producers with intellectual property reaching the Amateur status or above, a potential slot in the music/IP mortgage business entity's inventory.

The music/IP mortgage provider can also utilize two (2) additional “Status” Categories. However, IP producers qualifying in these categories may not need to be scored the same as others due to their established industry credentials. For example,

| | | |
|---|---|---|
| 5) | Star: | Sold 500,000 CD's or more (Gold) |
| 6) | Super Star: | Sold 1 million CD copies or more (Platinum) |

Individual IP producers in these categories can have their intellectual property placed in a catalogue of music to be sold at auction. Terms of the auction will be set by the IP producer. The music mortgage provider in this case can receive a percentage of the auction price of the IP product, for example a commission worth 50% of the auction price.

Products and Services:

For the Independent Artist/Group/IP Producer(s) Seeking Mass Marketing:

Mortgage loans secured by intellectual property (IP) product that will be disbursed in the form of services, including, but not limited to the following:

a. Legal advice and available support including contract negotiation and representation;

b. Overall image and portfolio development—serving as an incubation center for new and transitioning artist/IP producer;

c. Publishing management at a flat rate that can be included with the mortgage;

d. Technological distribution and support for the artist's/IP producer's work;

e. Opportunity to gain stable salaries and opportunity for creation via becoming a staff artist/IP producer.

B. For the Independent Artist/Group/IP Producer(s) Seeking Staff Work Opportunities:

a. Ability to write, produce, perform, design, and build IP products for a salary in return for the intellectual property rights to all work created;

b. All of the services shown above, should the artist/IP producer choose to pursue the mass market path;

c. Full total compensation packages, providing that the artist/IP producer is accepted.

C. Strengths: An embodiment of the present invention organizes independent distribution and removes the barriers to entry for artists/IP producers, which increases competition and develops additional talent.

a. Customer Demographic: Endless supply of potential customers and suppliers of intellectual property;

b. Connections to Specialists: Non-music/IP mortgage providers such as stylists, video directors, assistants, etc. can be contacted and kept on retainer.

D. Opportunities:

a. Expansion to Other Industries: Representation of other artists/IP producers outside of the music industry, particularly independent software developers, toy and industrial machine designers, and authors.

b. Talent Scout Services: music/IP mortgage provider's work with up and coming artists/IP producers may also enable music/IP mortgage provider to pass artists/IP producers who are looking for record company support to those record companies for a finder's fee.

E. Product and Service Pricing Structures

a. Studio Services for Music Production
i. Audio Services Offered, but are not limited to: Complete Album Production, Mixing/Remixing, Mastering, MIDI Programming, Writing, Arranging, Production and Post-Production, Studio Musicians, Voice Talent, A/V, Film Soundtracks and Scoring, Audio Archiving and Restoration, Advertising Production.
ii. Project-Based Rate System: Overall goals for the recording are discussed at origination, the studio budget is set for time and finances at that point. The budget will be monitored throughout the session to make sure that the artist is not overextended. Budgets are figured at a base rate of, in one example of the embodiment, $500/day, and/or $50/hour. Individual services will be discussed on a case-by-case basis.
iii. Hours of Service: Production days will include studio time, the full service of the facility, production, and engineering.

b. Recording Distribution
i. Brick and Mortar Retail Distribution: National on-demand distribution to physical stores including, but not limited to: Tower Records®, Circuit City®, Virgin® Megastores, Barnes and Noble®, Guitar Centers®, and smaller independent stores
ii. Global Online Distribution: Online Distribution will be available through leading online retailers including, but not limited to: Apple iTunes®, Napster®, Rhapsody®, Musicmatch®, Barnes&Noble.com®, TowerRecords.com®, Amazon.com®), and the like.
iii. Sales and Unit Tracking: All recordings submitted to Soundscan, to allow artists/IP producers to prove the number of units moved worldwide.
iv. Online Music Content and Article Sources: Artist and IP product information submitted to Muze®, Loudeye®, and All Music Guide®. online music content providers.
v. Warehousing and Fulfillment: Provided for all orders, allowing artists/IP producers to fulfill all order requests from one location.

c. Artist and Product Development
i. Agent and Legal Representation: Negotiation of live performance contracts, securing and managing bookings to completion, publicist services—a percentage of, for example, 20% of take from bookings, but negotiable on a case-by-case basis
ii. Career Guidance and Coaching: Career progression mapping, increasing opportunities for creativity, maintaining mental, emotional, and spiritual health for independent artists/IP producers, vocal and dance instruction—for example, $300 per all-inclusive session
iii. Image Consulting and Photography: In other embodiments of the invention, guidance in visual appearance, verbal and non-verbal communications, interviewing, etiquette, wardrobe consulting, hair styling, and makeover consulting is offered.
iv. Promotion and Publicity: Promotion to national music magazines, music blogs, music podcasts, Internet radio stations, street team support, introductions to industry insiders, press kit assembly and much more

d. Technological Support
i. Artist Website Support and Maintenance: Website design, building, testing, maintenance, stabilization, and expansion, purchasing and sharing capabilities, and other community and marketing capabilities as needed by the artist
ii. Digital Intellectual Property Management: Storage and maintenance of digital music, photographs, and other intellectual property is complementary to the artist.

e. Publishing and Royalty Management
i. Income Collection and Management: Supervision of collection and payment of publishing royalties for sales to writers, producers, and performers—complementary to artist.
ii. Intellectual Property Registration: Managing ownership matters and control rights to transcriptions and uses of musical works—complementary to artist.
iii. Use Opportunity Procurement: Securing of opportunities to use intellectual property for other endeavors, such as using a song in a commercial or movie—fee based on income from endeavor.

V. Marketing Plan

Market Research Planning

We can conduct extensive market research to determine demand for our three major profit centers: Royalty loan origination, staff and loan default royalties from publishing, and general music production services.

Primary Data: Interviews with area artists/IP producers, producers, and engineers in the major genres to determine interest in loan origination and creating independent labels.

Secondary Data: Research using archived articles and business information services such as Jupiter Research, Forrester, and other research companies

New and experienced IP producer e.g., singers, songwriters, bands, and producers who are interested in creating independent businesses or gaining steady pay from their art are motivated to build their own labels, and to learn more about the business via their interaction with us.

Record Companies

We are focused on serving record companies who are looking for new talent amongst our ranks (out of those artists/IP producers who are seeking major label deals), those record companies who are looking to outsource the talent scouting and artist/IP producer development functions of their businesses, and record companies who are looking for music to use for their own in-house artists/IP producers.

Record companies can act as both partners and competitors with music/IP mortgage providers. The music/IP mortgage provider can be situated in the market place to compete with traditional record companies for the best artists/IP producers, as well as for the best employees, particularly with those record companies who have full artist support service offerings and who do not choose to outsource those services to the music/IP mortgage provider.

The music/IP mortgage provider's value proposition for independent artists/IP producers is the provision of support and development that a major record label (in the case of the music industry), can provide, not only for a lower cost, but with the expressed intention of helping the independent artist/IP producer retain a larger percentage of their per-sales earnings as an independent business. The music/IP mortgage provider thereby reduces the independent artist's/IP producer's exposure to the music/IP mortgage provider by requiring a percentage of their publishing/IP rights long enough to resolve their obligations to the music/IP mortgage provider, and by not placing obligations on the independent artist/IP producer for the IP rights to their future music recordings/IP product.

Niche Independent Artist Support Companies: Indirect Competition

There are a number of smaller artist support companies that offer one or more of the major components of artist support, such as CD creation and distribution, product and image development, studio time and equipment, management and agent support.

These companies will act as both music/IP mortgage provider partners for outsourcing deals, but also as competitors in that artists/IP producers can deal directly with alternative partners for their services if they wish to do so.

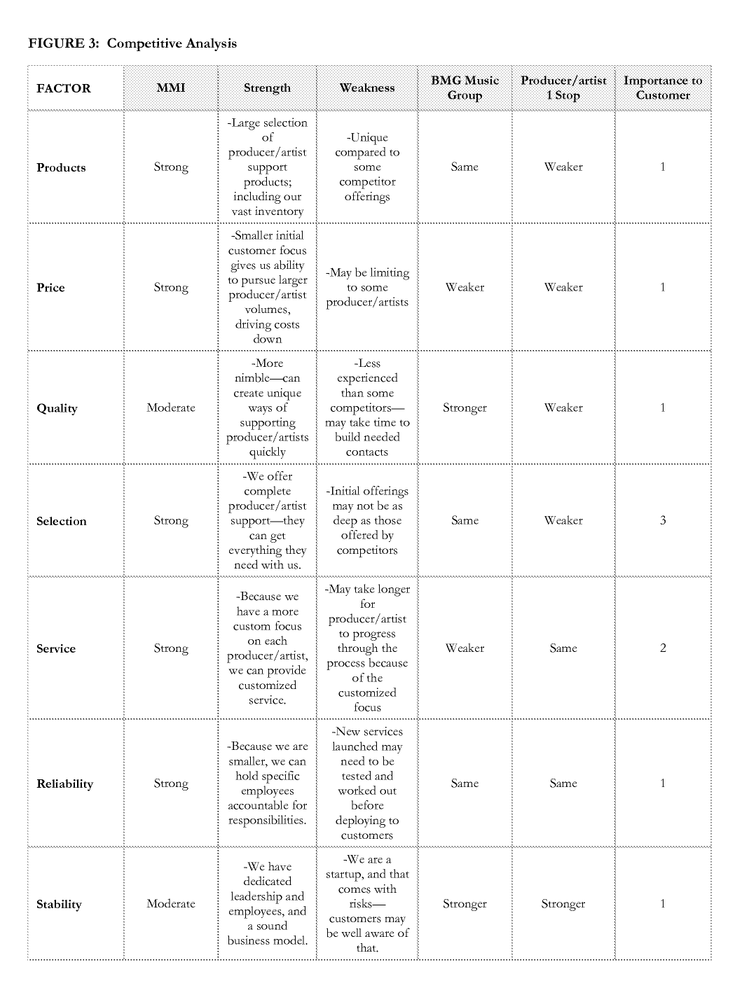

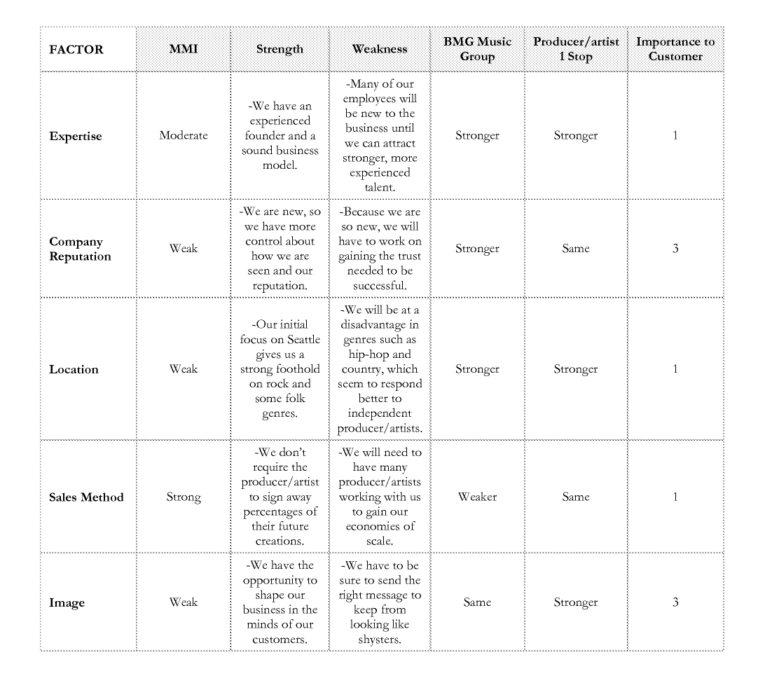

Referring now to FIG. 3 as shown in table, the music mortgage provider's value proposition in response to the above competition is that an artist/IP producer can find all aspects of support in one place, with one agreement, with the music mortgage provider, for a lower price than the artist/IP producer would pay using any number of the niche competitors in this market.

Niche. An embodiment of the present invention is dedicated to providing services to the artist/IP producer so that they have more control, more direction, and more share in the success of their IP products. By doing this, the music/IP mortgage provider can provide the artists/IP producers the financial freedom to define success in their own terms, based on what they, the artist/IP producer, are willing to invest in their IP product, their careers, and their businesses. Direct Marketing: Street Teams And Shameless Self-Promotion

Handing out cards at concerts, club nights, and other places and speaking to artists/IP producers and record company officials about the music mortgage provider's offerings can be one of the most effective and cost-conscious ways for the music mortgage provider to generate interest in the business methods and our services offered by the music mortgage provider. Strengths: This allows the music/IP mortgage provider to learn directly about what IP producers are expecting from the music/IP mortgage provider, and to bring that feedback directly back to inform the practices of music/IP mortgage provider business method. It also provides the artists/IP producers a real-time understanding about what services and benefits the music/IP mortgage provider provides to the IP producer.

Word of Mouth. Advertising can be from artists/IP producers who have had success with the provider and by recommending the music/IP mortgage provider to other artists/IP producers.

Trade Publication Advertising. One means of generating interest and knowledge about the music/IP mortgage provider's services can focus on local advertising in smaller newspapers and magazines that are well-read and quoted in the communities in which the music/IP mortgage provider are active. For instance, rather than publishing in national music magazines such as Guitar Monthly, a local Seattle based music/IP mortgage provider can opt to publish in a targeted local magazine, such as the Stranger, a well known tabloid in Seattle, Wash.

Customer Relationship Management. An embodiment of the present invention includes a database of all customers, their preferences, their purchases, and any feedback they have given regarding improvement of the business. The music/IP mortgage provider can periodically contact IP producers/previous customers with information regarding additional services that the music/IP mortgage provider has determined by the survey to be of interest to the IP producer.

Pricing. An embodiment of the present invention reduces costs to the IP producer by reducing the prices of services, as the music/IP mortgage provider's intended customers are likely to make decisions based heavily on price. The music/IP mortgage provider's business menu of pricing will allow the artist/IP producer a choice in how and when they will use the support the music mortgage provider offers—there is not the necessity to take an entire package of services all at the same time. This allows artists/IP producers to develop their businesses and their careers at their own pace.

Customer service and support will be part of every item that is offered.

In one preferred embodiment the music/IP mortgage provider provides its business method from a web-based site via e-commerce, for example, at one of three exemplary websites: MusicMortgage.com, MusicMortgage.org, or GenreCity.com. It is to be understood, that in later stages of the music/IP mortgage business method development and as the customer partnership develops, the music/IP mortgage provider can have a network of partners, preferably nearest the physical location of IP producers/customers, that will be able to fulfill IP producers/customer needs such as studio work and image consulting wherever the IP producer/customer is located. This will put emphasis on the music/IP mortgage producer's promotional structure.

VI. Operational Plan

Production. The music/IP mortgage provider's products and services are provided at the point of the IP producer's/customer's interaction with the music/IP mortgage provider and/or partners, and are produced by the methods the music/IP mortgage provider and/or partners use to create the IP products. Methods of production, distribution, etc., must meet the music/IP mortgage provider's standards and are of utmost quality for the IP producer/ customer.

Legal Environment

Can include:
Licensing and bonding requirements
Permits
Health, workplace, or environmental regulations
Special regulations covering your industry or profession
Zoning or building code requirements
Insurance coverage
Trademarks, copyrights, or patents (pending, existing, or purchased).

The embodiments of the invention in which an exclusive property or privilege is claimed are defined as follows:

1. A method for consulting, managing, and production wherein a business entity provides intellectual property leveraging strategies, accounting, and finance methods for individual IP producers, comprising:
performing an evaluation of an IP product based on the IP market strength of the IP product produced by an IP producer;
determining the IP producer's IP needs to produce said IP product, wherein those needs include at least one of the group of IP development, production, marketing, or distribution;
establishing and documenting a mortgage for the IP producer based on the producer's IP needs and the evaluated IP market strength of the IP product, wherein business entity takes a financial interest in IP produced; and
providing IP needs to said IP producer to produce said IP product, wherein those needs include at least one of the group of IP development, production, marketing, or distribution.
